(19) United States
(12) Patent Application Publication
(10) Pub. No.: US 2003/0156118 A1
(43) Pub. Date: Aug. 21, 2003

(54) Method and system for cleaning images to highlight information recorded on a background surface

(76) Inventor: Olugbenga Ayinde, Calgary (CA)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/077,814

(22) Filed: Feb. 20, 2002

(51) Int. Cl. G06K 9/40

(52) U.S. Cl. 345/589; 345/620

(57) ABSTRACT

A method of cleaning an image of a background surface on which information has been recorded includes for each pixel pᵢⱼ in the image, creating an array holding grayscale values of neighbor pixels within a region surrounding the pixel pᵢⱼ. The average grayscale value of the neighbor pixels is calculated and then thresholded. The grayscale value of the pixel pᵢⱼ is compared with the thresholded average grayscale value. If the grayscale value of the pixel pᵢⱼ is darker than the thresholded average grayscale value, the pixel is retained. Otherwise, the pixel value is set to bright. For each retained pixel, the colour value of the pixel pᵢⱼ and an average colour value are used to determine the output colour of the retained pixel in the cleaned image.

### FIELD OF THE INVENTION

The present application relates generally to image processing and in particular to a method and system for cleaning an image to highlight information such as writing and/or drawing, recorded on a background surface.

### BACKGROUND OF THE INVENTION

During meetings, background surfaces such as whiteboards, chalkboards, flipchart pads, and tackboards are commonly used to record information. In collaborative environments, several users may view, supplement and/or edit information recorded on these background surfaces. In situations where the background surfaces are passive, it is difficult and cumbersome to transfer information recorded on the background surfaces to other media that facilitates storage and retrieval of the recorded information.

To deal with the above problem, automated capture systems to capture information recorded on a background surface have been considered. These automated capture systems include for example, automated copyboards, flipchart scanners, active or specialized pen systems based on acoustic time-of-flight, electromagnetic detection, or laser scanning as well as analog resistive whiteboards. Although these automated capture systems have permitted information recorded on a background surface to be transferred to other media types, these automated capture systems suffer disadvantages.

In addition to the automated capture systems referred to above, camera-based systems to capture information recorded on background surfaces have been considered. For example, U.S. Pat. No. 5,529,290 to Saund discloses a device for transcribing markings drawn on a background surface such as a whiteboard or blackboard, into an electronic form using a camera-based scanner. The scanner is in the form of a video camera mounted on a computer-controlled pan/tilt head that is suspended from the ceiling or mounted to one side of the background surface. The video camera is directed successively at small regions or tiles of the background surface and snapshots of camera image tiles are captured until a complete image of the entire background surface is obtained. The camera image tiles slightly overlap with neighboring tiles so that a complete image of the entire background surface is obtained with no missing spaces.

Center-surround processing is performed on each camera image tile to compensate for lightness variations among and within the camera image tiles. Specifically, for each pixel pᵢⱼ in the camera image tile, a local average of pixel intensities in a window of a prescribed size centered around the pixel pᵢⱼ is computed. The average intensity is then subtracted from each pixel pᵢⱼ and the resulting pixel value is output. The resulting output pixels represent the difference at each pixel between its original value and the average value of the pixels in the surrounding window.

U.S. Pat. No. 5,581,637 to Cass et al discloses a device for transcribing markings drawn on a background surface such as a whiteboard or blackboard, into an electronic form using a video camera. A registration light pattern is projected onto the background surface to be imaged. The projected pattern is selected to suit the properties of the video camera and the imaging environment. The video camera is directed successively at tiles of the background surface and snapshots of the camera image tiles are captured until a complete image of the entire background surface is obtained. The pattern markings are processed using perspective transformations to determine the overlap properties of the captured camera image tiles and the distortion of each camera image tile. The resulting data is used to combine the camera image tiles to produce an undistorted image of the entire background surface. Similar to the above-mentioned Saund patent, center-surround processing is performed on each camera image tile to compensate for lightness variations among and within the camera image tiles.

Unfortunately, the center-surround process implemented in the Saund and Cass et al devices does not reduce the number of pixels within the camera image tiles to those that represent information of value such as writing and/or drawing on the background surface. Rather, the center-surround process normalizes the colour of the pixels in the camera image tiles. As a result, processing of the colour normalized images is computationally expensive. Accordingly, techniques to clean images are desired.

It is therefore an object of the present invention to provide a novel method and system for cleaning images to highlight information such as writing and/or drawing, recorded on a background surface.

### SUMMARY OF THE INVENTION

According to one aspect of the present invention there is provided a method of cleaning an image of a background surface on which information has been recorded, said method comprising the steps of:

for each pixel pᵢⱼ under consideration that is in said image:

comparing the pixel pᵢⱼ with neighbor pixels within a region surrounding said pixel pᵢⱼ to determine whether said pixel pᵢⱼ represents information or said background surface; and

if the pixel pᵢⱼ represents said background surface, assigning the pixel pᵢⱼ a value to contrast pixels representing information.

According to another aspect of the present invention there is provided a method of cleaning an image of a background surface on which information has been recorded, said method comprising the steps of:

for each pixel pᵢⱼ in said image:

creating an array holding grayscale values of neighbor pixels within a region surrounding said pixel pᵢⱼ;

calculating the average grayscale value of said neighbor pixels and thresholding said average grayscale value;

comparing the grayscale value of the pixel pᵢⱼ with the thresholded average grayscale value; and

retaining the pixel pᵢⱼ in said image if the grayscale value of said pixel differs from said thresholded average grayscale value, otherwise setting the value of the pixel pᵢⱼ to contrast pixels pᵢⱼ retained in said image.

Preferably, the method further includes the step of adjusting the colour of each retained pixel to compensate for colour added to the image during capturing of the image by a camera. The average colour of the image or the average colour of the region is used to determine the colour added to the image by the camera.

In the preferred embodiment, pixels representing the background surface are set to white and the region is centered around the pixel pᵢⱼ. It is also preferred that the creating step includes the steps of using a region value N to determine the size of the region surrounding the pixel pᵢⱼ and using an interval value M to determine the pixels within the region that are designated as neighbor pixels. The region value N designates a region including N×N pixels surrounding the pixel pᵢⱼ and the interval value M designates every Mth pixel in the region as a neighbor pixel.

Preferably, during thresholding the average grayscale value is multiplied by a threshold value having a value in the range of from about 0.90 to 0.95. It is also preferred that the creating step further includes the step of padding the array with additional grayscale pixel values copied from the margins of the image.

According to yet another aspect of the present invention there is provided a computer product including a computer program embodied thereon for cleaning an image of a background surface on which information has been recorded, said computer program comprising:

computer program code for comparing each pixel pᵢⱼ under consideration that is in said image with neighbor pixels within a region surrounding said pixel pᵢⱼ to determine whether said pixel pᵢⱼ represents recorded information or said background surface; and

computer program code for assigning the pixel pᵢⱼ under consideration a value to contrast pixels representing recorded information if the pixel pᵢⱼ represents said background surface.

According to still yet another aspect of the present invention there is provided a camera-based system for capturing an image of a target area comprising:

a generally horizontally extending boom assembly, said boom assembly being positioned above a background surface;

at least one digital camera mounted on said boom assembly at a location spaced from the plane of said background surface, said at least one digital camera being oriented so that the field of view thereof encompasses said background surface; and

a controller in communication with said at least one digital camera, said controller receiving image data from said at least one digital camera and processing said image data to form a cleaned digital image of said background surface, during said cleaning said controller retaining only pixels representing information recorded on said background surface.

The present invention provides advantages in that since neighbor pixels of each pixel under consideration are used to decide whether a pixel is retained in the cleaned image or set to white, the image background can be cleaned very quickly yielding a cleaned image that can be further processed without requiring excessive processing resources.

### BRIEF DESCRIPTION OF THE DRAWINGS

An embodiment of the present invention will now be described more fully with reference to the accompanying drawings in which:

FIG. 1 is an isometric view of a camera-based system for capturing images of a background surface in accordance with the present invention;

FIG. 2 is an exploded isometric view of a boom assembly forming part of the camera-based system illustrated in FIG. 1;

FIG. 3 is a block diagram of a digital camera forming part of the boom assembly illustrated in FIG. 2;

FIG. 4a is a front elevational view of a controller forming part of the camera-based system illustrated in FIG. 1;

FIG. 4b is an isometric view of the controller illustrated in FIG. 4a ;

FIG. 5 is a block diagram of the controller internal circuitry;

FIG. 6 shows a pixel array forming part of an image captured by the camera-based system of FIG. 1;

FIG. 7 shows a padded pixel array;

FIG. 8 is a flow chart showing the steps performed by the controller during an image cleaning process;

FIG. 9a is an image of a background surface captured by the camera-based system of FIG. 1; and

FIGS. 9b to 9f are cleaned images corresponding to the image of FIG. 9a, for different region size and interval values.

### DETAILED DESCRIPTION OF THE PREFERRED EMBODIMENT

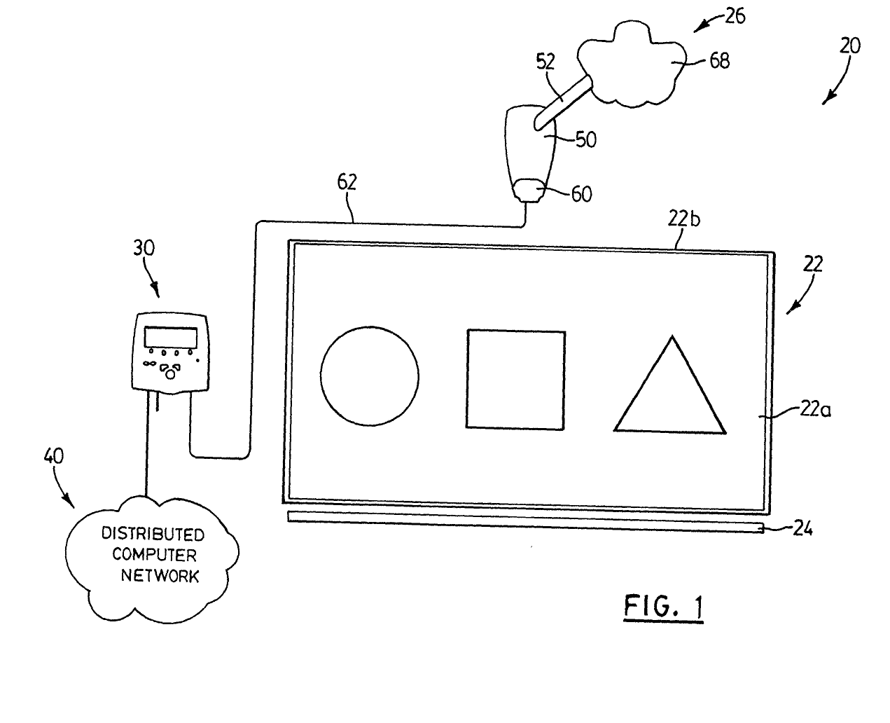

Turning now to FIG. 1, a camera-based system for capturing images of a background surface and automatically posting the images to an Internet accessible site in accordance with the present invention is shown and is generally identified by reference numeral 20. As can be seen, the system 20 includes a whiteboard 22 mounted on a wall surface. In this embodiment, the whiteboard 22 includes a generally planar rectangular board surface 22a bordered by a frame 22b. An elongate tool tray 24 is disposed slightly below the whiteboard 22 and supports tools including dry-erase ink pens and an eraser. Using the pens and eraser, information such as writing and/or drawing can be recorded on the whiteboard 22, as well as edited and erased. In FIG. 1, a circle, a square and a triangle have been drawn on the surface 22a of the whiteboard 22.

A boom assembly 26 is also mounted on the wall surface slightly above the midpoint of the whiteboard 22. The boom assembly 26 extends outwardly from the wall surface in a generally horizontal orientation a distance equal to about 30 to 50 inches. A controller 30 is also mounted on the wall surface to one side of the whiteboard 22 and communicates with the boom assembly 26 and with a distributed computer network 40.

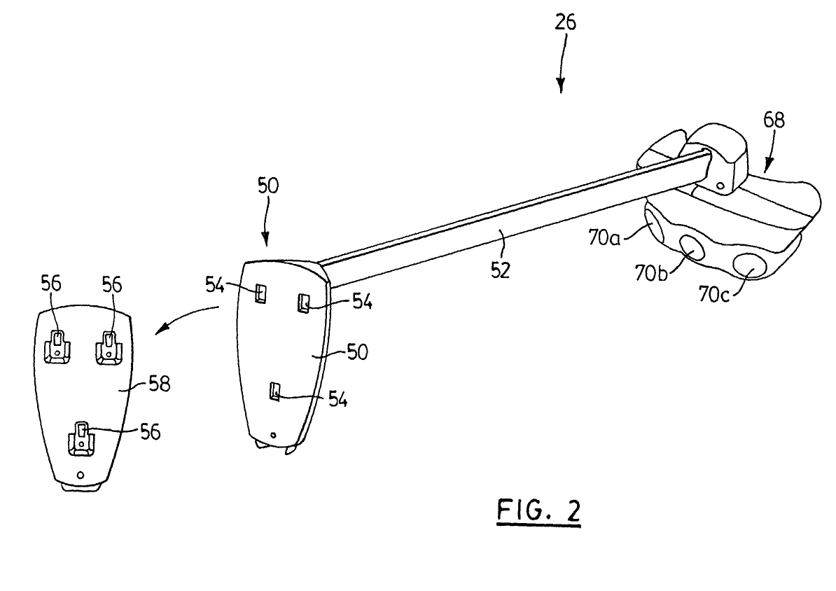

FIG. 2 better illustrates the boom assembly 26 and as can be seen, boom assembly 26 includes a wall mount 50 receiving one end of an elongated boom 52. Wall mount 50 has a plurality of slots 54 formed in its rear surface. The slots 54 releasably receive complimentary tabs 56 on a mounting plate 58 that is secured to the wall surface by suitable fasteners (not shown). The wall mount 50 also includes a pivoting cap 60 (see FIG. 1) that can be moved to expose a pair of plug-in high speed serial data communication ports (not shown). One of the data communication ports receives a cable 62 that extends to the controller 30. The other data communication port is designed to receive a cable leading to the wall mount of an adjacent boom assembly when a number of whiteboards and boom assemblies are chained together.

A camera head 68 is disposed on the opposite end of the boom 52 and supports three digital cameras 70a to 70c . The digital cameras 70a to 70c are aimed back towards the whiteboard 22, with each digital camera being fitted with an appropriate field-of-view lens so that it captures a different section or tile of the whiteboard surface 22a. The field-of-view lenses are however selected so that there is a small overlap in the camera images captured by adjacent digital cameras. Since the boom assembly 26 is positioned above the whiteboard 22 and is short, a user standing in front of the whiteboard typically remains outside of the fields of view of the digital cameras 70a to 70c. As a result, the digital cameras 70a to 70c typically have an unobscured view of the whiteboard 22.

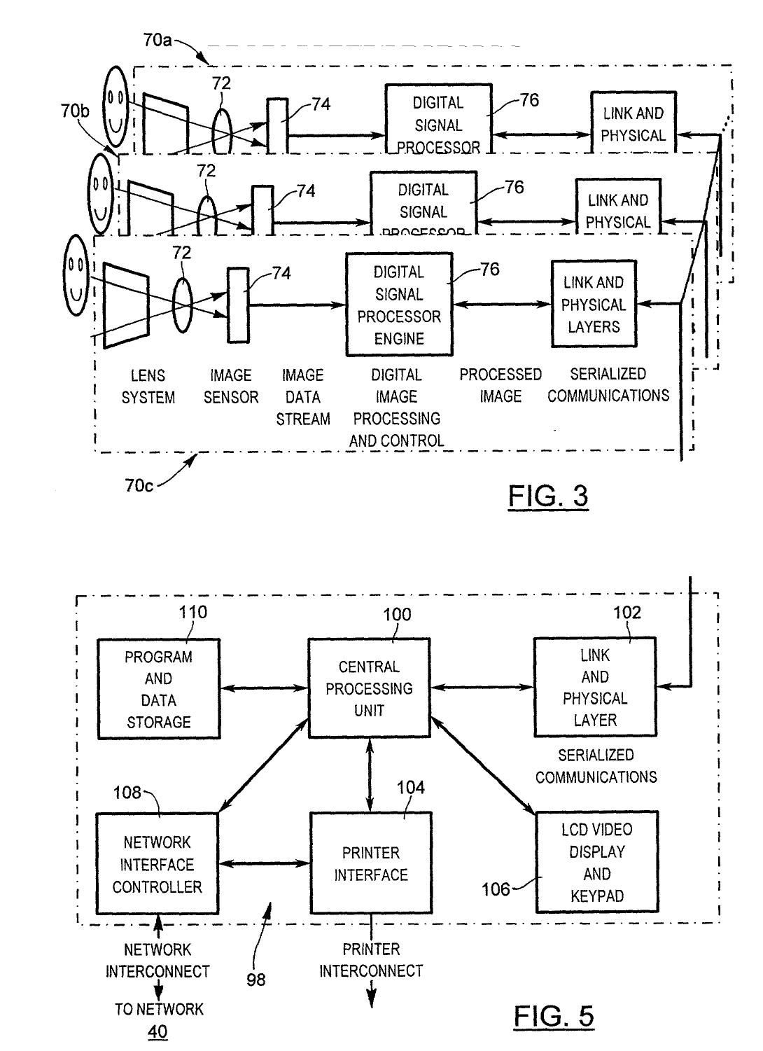

Turning now to FIG. 3 the digital cameras 70a to 70c within the camera head 68 are better illustrated. As can be seen, each digital camera includes a lens system 72 and an image sensor 74. A digital signal processor (DSP) engine 76 is connected to the image sensor 74 and to the high-speed serial data communication ports by cables (not shown) running through the boom 52.

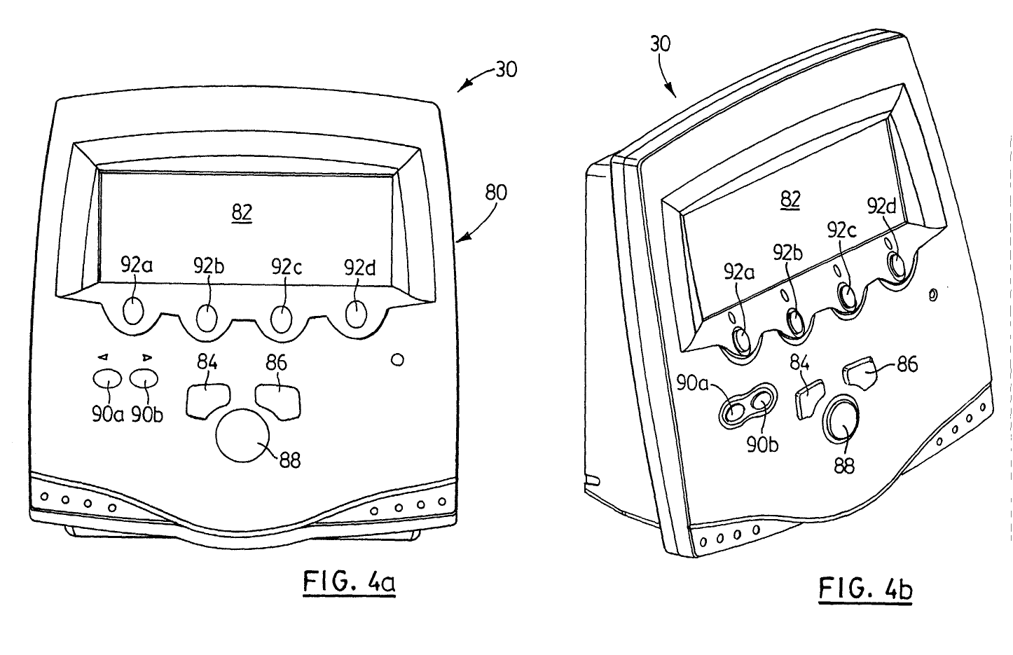

FIGS. 4a to 4b better illustrate the controller 30. As can be seen, controller 30 includes a housing 80 having a liquid crystal display screen 82 and a series of user selectable controls in the form of depressable buttons. In this particular embodiment, the buttons include a session open button 84, a session close button 86 and a capture image button 88. A pair of scroll buttons 90a and 90b allow a user to scroll through features presented on the display screen 82. Buttons 92a to 92d allow features presented on the display screen 82 to be selected.

FIG. 5 illustrates the internal circuitry 98 within the housing 80. As can be seen, the internal circuitry 98 includes a central processing unit (CPU) 100 communicating with a high speed serial data communication port 102, a printer interface 104, an LCD video display and a keypad driver 106, a network interface controller 108 and memory 110. High-speed data communication port 102 receives the cable 62 leading to the wall mount 50 of the boom assembly 26. LCD video display and keypad driver 106 drives the display screen 82 and the buttons 84 to 92d. Printer driver 104 is coupled to a port accessible through the housing 80 that is designed to receive a cable extending to an external printer. Printer driver 104 is also coupled to the network interface controller 108.

The central processing unit 100 includes Internet server capabilities and executes software loaded in the memory 110 so that image data output by the digital cameras 70a and 70c can be processed, converted into digital images in .JPEG format and made accessible to users through the distributed computer network 40. In this manner, users can access the digital images through web client applications such as web browsers. Further specifics concerning the operation of the system 20 will now be described.

Using the system 20 is very simple regardless of the technical skill level of the user. The controller 30 does not need to be operational prior to drawing or writing on the surface 22a of the whiteboard 22. Once information is recorded on the surface 22a of the whiteboard 22, images of the recorded information can be acquired provided a session is open. If a session is not open, the user simply needs to press the session open button 84 to open a session. When the session open button is pressed, the CPU 100 creates a session so that all images captured within the open session are stored collectively in a file folder. With a session open, in order to capture images, the user simply needs to press the capture image button 88. When the capture image button 88 is pressed, the CPU 100 signals each digital camera causing each digital camera to capture an image of the section or tile of the whiteboard 22 within its field of view. As mentioned previously, because the boom assembly 26 is short and is positioned close to the whiteboard 22 and slightly above it, the user recording information on the whiteboard is rarely in the fields of view of the digital cameras 70a to 70c. As such, the user typically does not need to move away from the whiteboard when images of the whiteboard 22 are being acquired by the digital cameras 70a to 70c.

During imaging, the DSP engine 76 of each digital camera acquires raw image data from the image sensor 74 and conveys the raw image data to the CPU 100 over a high speed data communications link via the cable 62. When the CPU 100 receives the raw image data, the CPU converts the raw image data into colour images of the whiteboard sections, cleans the colour images and then stitches the cleaned colour images together to form a complete image of the whiteboard 22. In order to stitch adjacent camera images together, the background surface includes target references or cross-hairs (not shown) thereon that are positioned so that each adjacent camera image captures a common pair of target references. The common target references captured in adjacent camera images allow the camera images to be easily stitched together. Other stitching methods can of course be used including that disclosed in U.S. Pat. No. 5,528,290 to Saund.

During cleaning background shades of white created in various lighting conditions are removed so that only high contrast colour pen strokes on a white or empty background remain in the colour images. This helps to keep the size of the complete image manageable so that additional processing of the complete image is not computationally expensive. The CPU 100 then saves the complete image in a desired format, in this embodiment .JPEG format.

With the electronic image processed as above, the CPU 100 conditions the LCD video display and keyboard driver 106 to present the complete image on the display screen 82 to provide quick visual feedback to the user. A copy of the digital image may also be sent to a designated secondary storage location such as a personal computer forming part of the distributed computer network 40.

If desired, a user can select a print command using the option buttons on the housing 80. When the CPU 100 receives a print command, the CPU 100 outputs the electronic image to the printer driver 104 which in turn outputs the electronic image either to a printer coupled to the printer driver port or to the network interface controller 108 so that the electronic image can be printed by a network printer in the distributed computer network 40.

When the user is finished a session, the user simply needs to push the close session button 86. If the user wishes to continue using the system 20, a new session must be opened by pushing the open session button 84. Images captured during the new session are saved and posted separately.

With the complete image cleaned and saved, the complete image can be posted to an Internet accessible site. Specifics of this process are set forth in U.S. patent application Ser. No. 09/876,230 filed on Jun. 18, 2001, assigned to the assignee of the present invention, the contents of which are incorporated herein by reference and therefore, will not be discussed further herein.

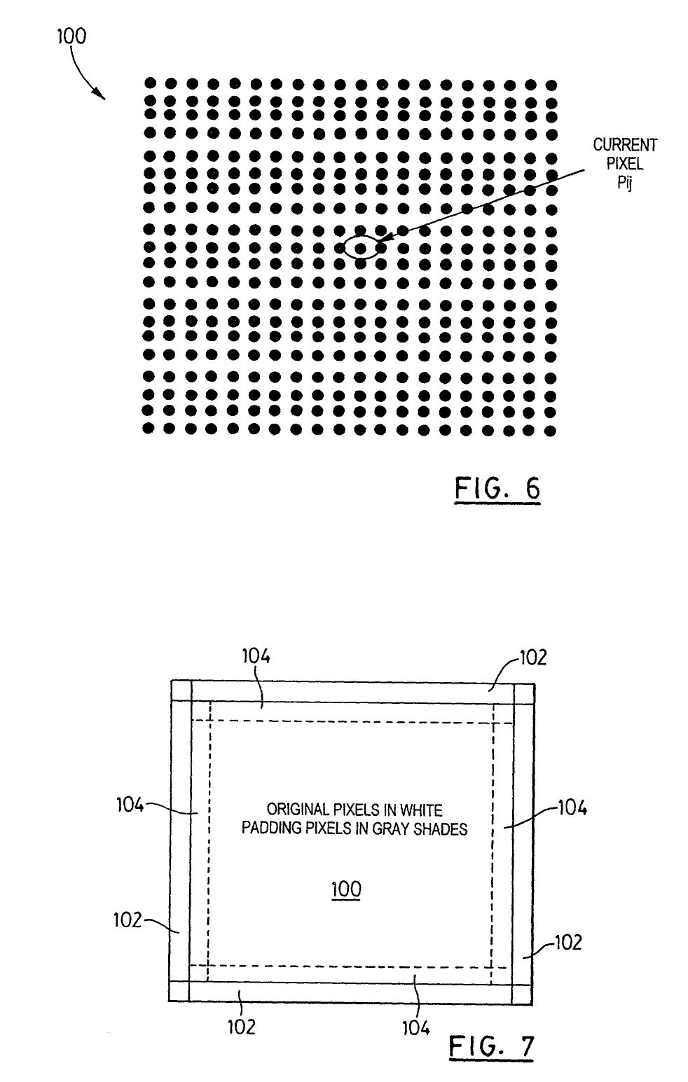

Referring now to FIGS. 6 to 8, the image cleaning process performed by the CPU 100 on each camera image prior to stitching of the camera images will now be described. During the image cleaning process, each pixel pᵢⱼ in the camera image is compared with neighboring pixels within a region 100 centered around the pixel pᵢⱼ under consideration to determine whether that pixel represents recorded information such as writing and/or drawing, on the background surface 22a. If the pixel pᵢⱼ represents recorded information, the pixel is retained in the cleaned image. Otherwise, the pixel pᵢⱼ is set to a value to contrast pixels retained in the cleaned image. In this case, pixels representing the board surface 22a are set to a bright pixel value such as white.

Initially during the image cleaning process, a selectable region size N is used to establish the region 100 of pixels centered around and considered to be eligible neighbors of the pixel pᵢⱼ . For example, a region size N equal to twenty (20), specifies a 20×20 region of neighbor pixels centered around the pixel pᵢⱼ as shown in FIG. 6. An interval M is also used to establish the actual pixels within the region 100 that are designated as neighbors of the pixel pᵢⱼ. For example an interval M equal to four (4), results in every fourth pixel within the region 100 being designated as an actual neighbor pixel. As will be appreciated, the values of the region size N and the interval M determine the nature of the image cleaning effect. If thick portions of recorded information are to be retained in cleaned camera images, large region size and interval values should be used. Otherwise, smaller region size and interval values are preferred. Of course the ideal interval value is one (1), although using such an interval value has an impact on processing speed.

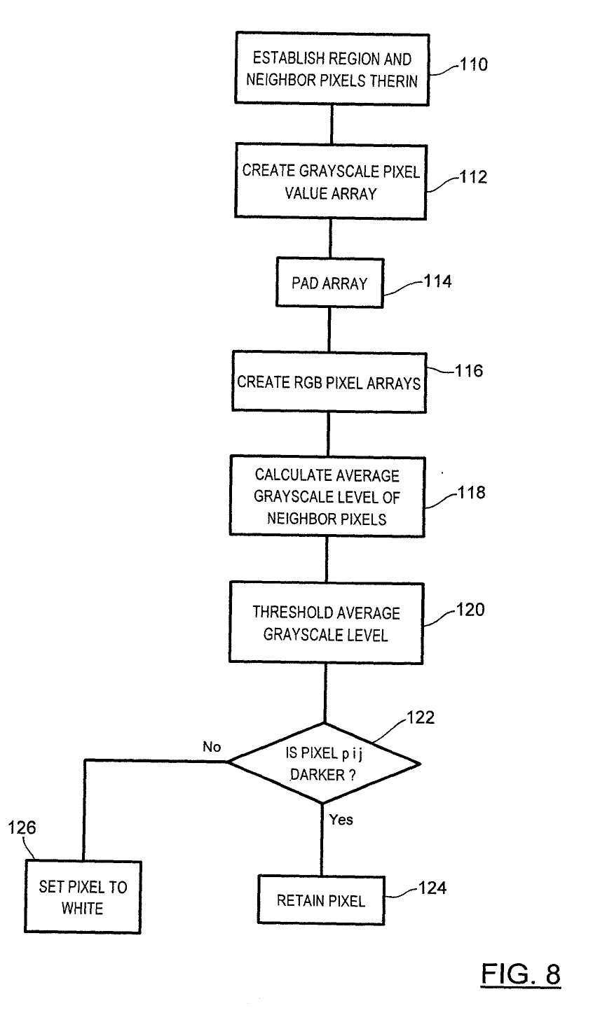

With the region size and interval values established (see step 110 in FIG. 8), an array is created to hold the grayscale values of the colour pixels in the camera image (step 112). The grayscale pixel array is then enlarged on all four sides by padding the grayscale pixel array with additional grayscale pixels 102 as shown in FIG. 7 (step 114). The additional grayscale pixels 102 are copied from the peripheral margins 104 of the original array 100 of grayscale pixels as shown by the dotted lines in FIG. 7. The padding size is selected to be equal to one half of the region size N. The padding is used to inhibit a dark margin from appearing around the periphery of the cleaned image.

Arrays holding the RGB pixel values of the camera image corresponding to the grayscale pixel array are also created (step 116). These RGB pixel values are used to enhance the colour of pixels retained in the cleaned image if the average colour of the region 100 is to be used instead of the average colour of the camera image during colour enhancement of output pixels as will be described.

For every pixel pᵢⱼ in the camera image, the average grayscale level of the designated neighbor pixels within the region 100 surrounding the pixel pᵢⱼ as determined by the region size and interval values is calculated (step 118). The calculated grayscale level is then multiplied by a threshold value in the range of about 0.90 to 0.95 (step 120). The resulting product is compared with the pixel pᵢⱼ under consideration (step 122). If the pixel pᵢⱼ under consideration is darker than the resulting product, the pixel pᵢⱼ is retained in the cleaned image (step 126). Otherwise the pixel pᵢⱼ is set to white. Since this process is performed on each pixel pᵢⱼ in the camera image, only pixels representing recorded information on the background board surface 22a are retained in the cleaned image. All other pixels are set to white. The result is a cleaned image that highlights information recorded on the board surface 22a.

With the retained pixels pᵢⱼ of the camera image known, the average RGB colours of the camera image are computed using the arrays holding the RGB pixel values that are created at step 116. Prior to outputting the retained colour pixels pᵢⱼ it is desired to enhance the pixel colours. This is due to the fact that the digital cameras 70a to 70c tend to add a layer of colour to the captured images. To compensate for the added layer of colour, for each pixel pᵢⱼ that is retained in the image, the average colour of the region 100 within which that pixel pᵢⱼ is located, is calculated to determine the layer of colour added to the image by the digital camera. This allows the degree by which the colour of the retained pixel pᵢⱼ has been washed by the added colour layer to be determined. The calculated average colour can then be used to readjust the colour of the retained pixel pᵢⱼ to take into account the colour washing.

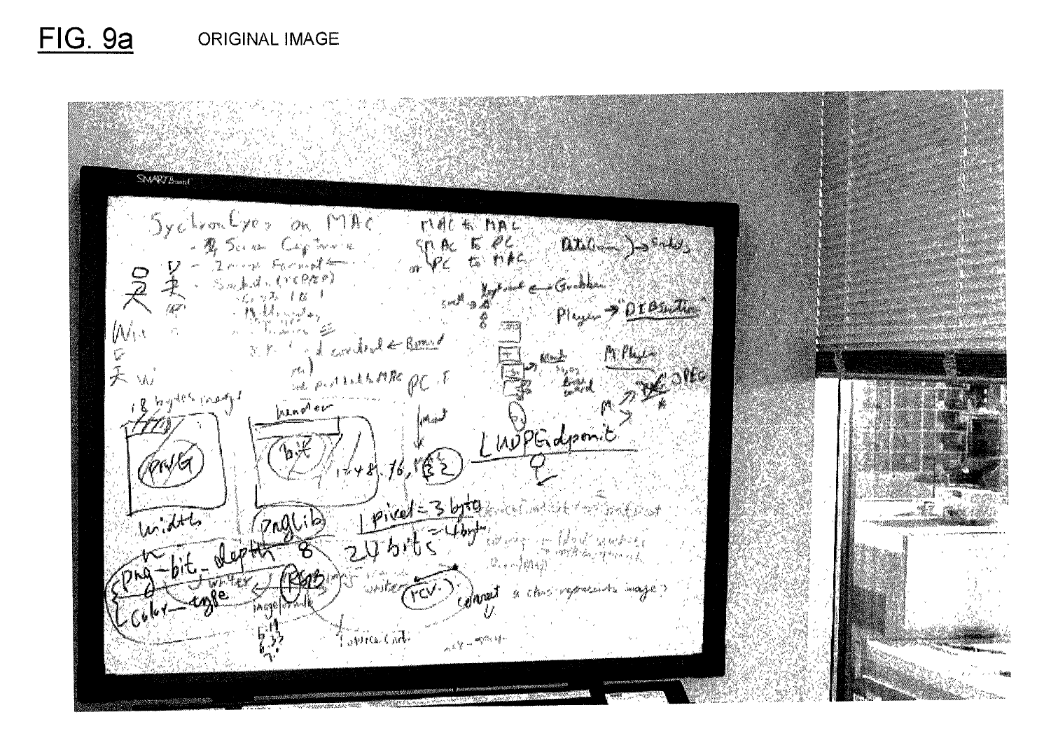

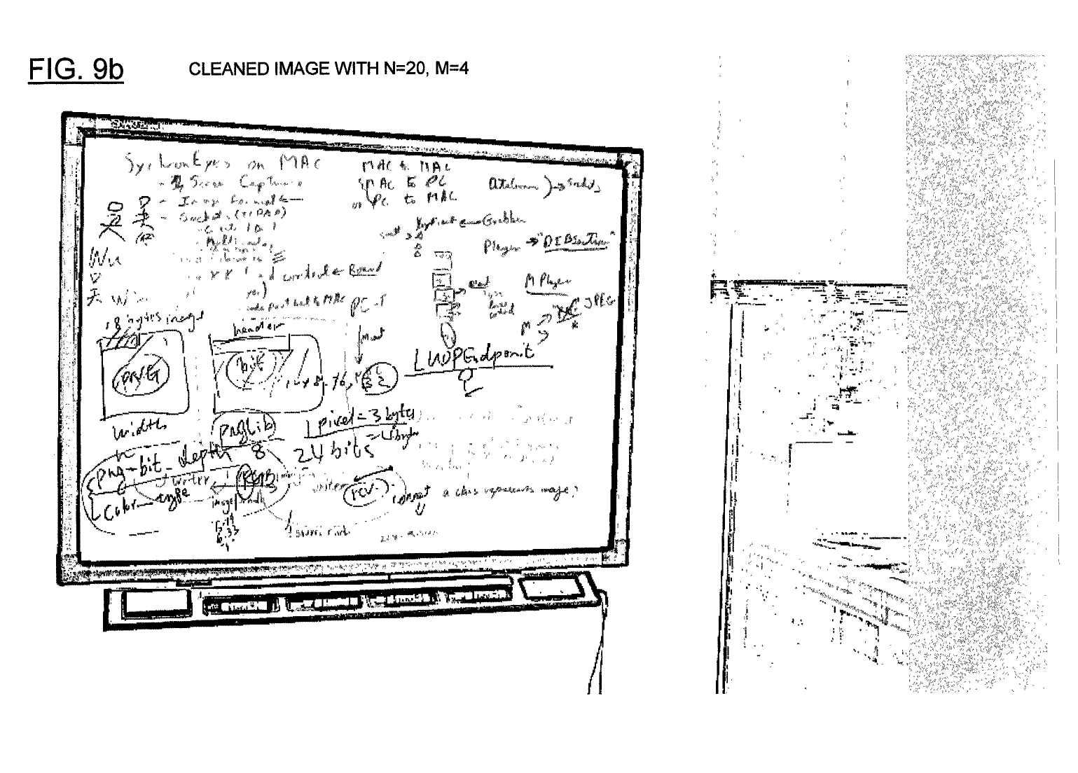

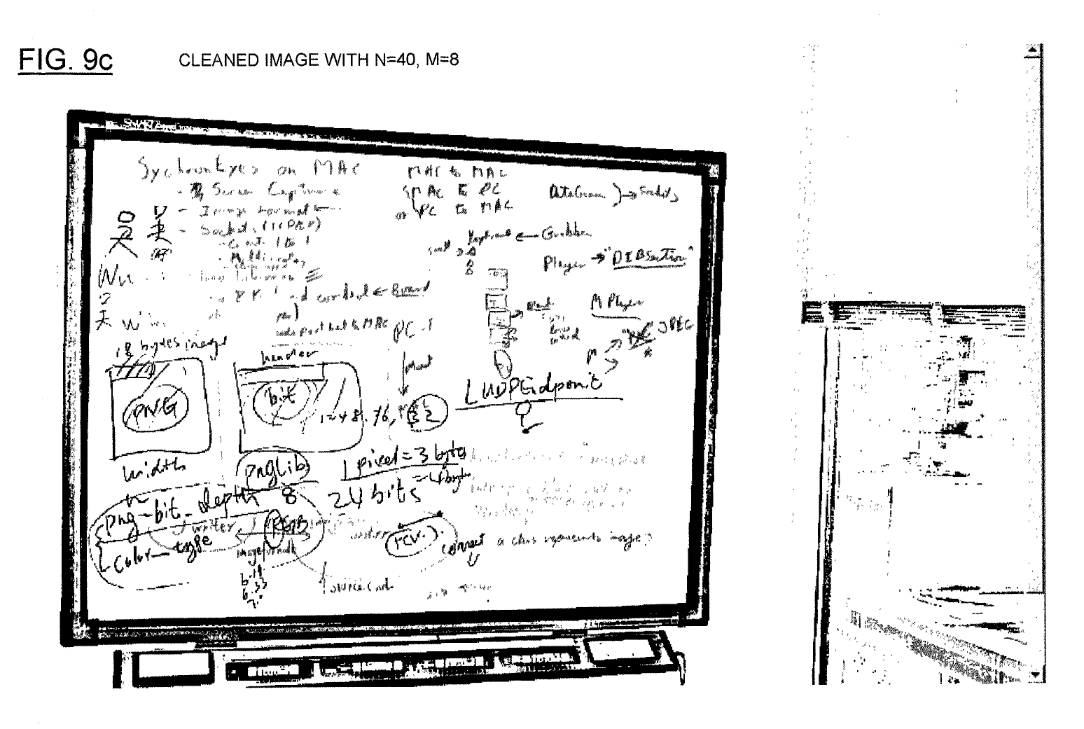

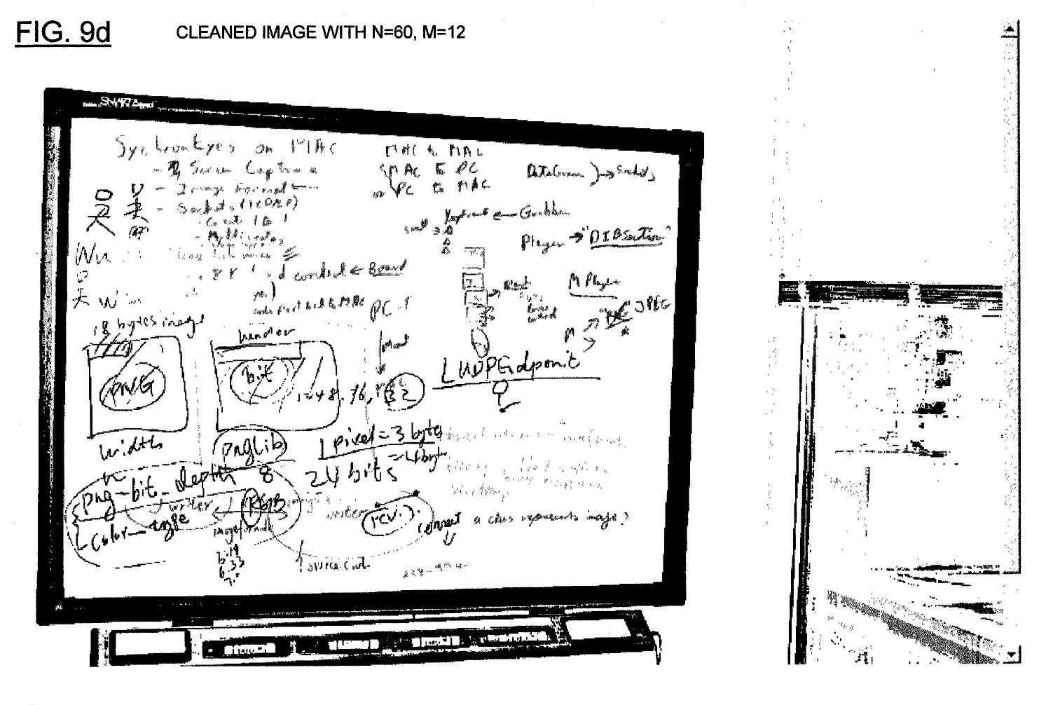

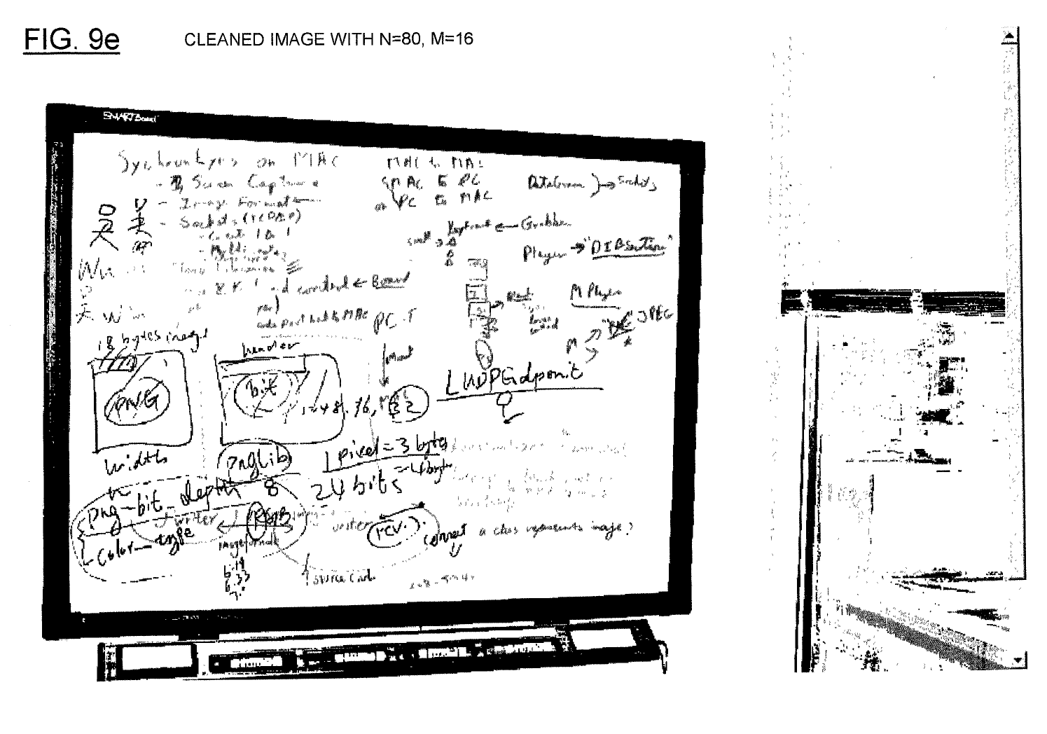

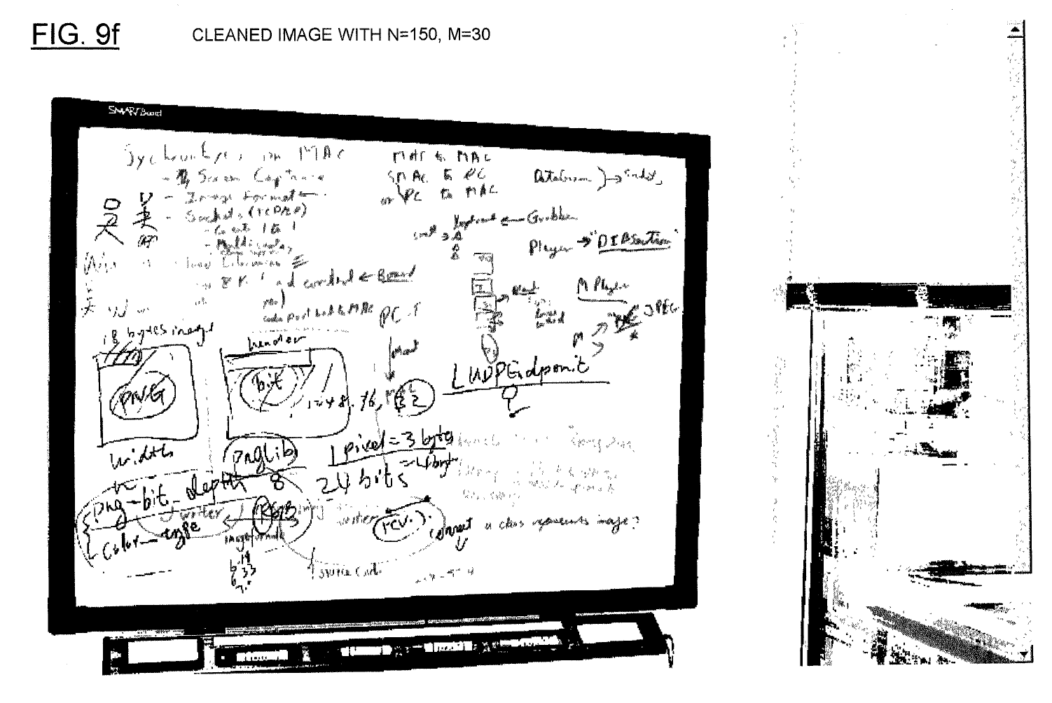

Turning now to FIG. 9a, a captured image of a background surface on which information has been recorded is shown. As mentioned previously, the region size N and interval M are selectable and are chosen to yield the desired image cleaning effect. FIGS. 9b to 9f show cleaned images corresponding to the image of FIG. 9a where different region size N and interval M values are selected. In particular, FIG. 9b shows a cleaned image using a region size N equal to 20 and an interval M equal to 4. FIG. 9c shows a cleaned image using a region size N equal to 40 and an interval M equal to 8. FIG. 9d shows a cleaned image using a region size N equal to 60 and an interval M equal to 12. FIG. 9e shows a cleaned image using a region size N equal to 80 and an interval M equal to 16. FIG. 9f shows a cleaned image using a region size N equal to 150 and an interval M equal to 30.

The creation of the arrays holding the RGB pixel values is optional and depends on the application in which the image cleaning process is being used. Rather than creating the arrays holding the RGB pixel values and then computing the average RGB colours for the region 100, if desired this step can be eliminated. If this step is eliminated, the average image colour and the original RGB colours of retained pixels pᵢⱼ are used to determine the colour of the output pixel to compensate for the colour washing.

As will be appreciated, by comparing each image pixel with neighbor pixels to decide whether the image pixel is to be retained in the cleaned image or set to white, the image can be cleaned very quickly yielding a cleaned image that can be further processed without requiring excessive processing resources. The image cleaning processing speed and requirements are of course a function of the region size and interval values that are selected.

Although the present invention has been described with reference to a camera-based system that takes images of a whiteboard, those of skill in the art will appreciate that the present invention may be used to clean images of a background surface of basically any colour where it is desired to highlight information, such as writing and/or drawing, recorded on the background surface.

It will also be appreciated that the cleaning of images need not be performed in real-time. Images captured by the camera-based system that have been saved, can be retrieved for subsequent cleaning.

Although a preferred embodiment of the present invention has been described, those of skill in the art will appreciate that variations and modifications may be made without departing from the spirit and scope thereof as defined by the appended claims.

What is claimed is:

1. A method of cleaning an image of a background surface on which information has been recorded, said method comprising the steps of:
for each pixel pᵢⱼ under consideration that is in said image:
comparing the pixel pᵢⱼ with neighbor pixels within a region surrounding said pixel pᵢⱼ to determine whether said pixel pᵢⱼ represents recorded information or said background surface; and
if the pixel pᵢⱼ represents said background surface, assigning the pixel pᵢⱼ a value to contrast pixels representing recorded information.

2. The method of claim 1 wherein each pixel pᵢⱼ in said image is under consideration.

3. The method of claim 2 wherein the colour values of pixels representing recorded information are retained in said image and wherein the values of pixels representing said background surface are set to a bright value.

4. The method of claim 3 wherein said bright value is white.

5. The method of claim 4 wherein said region is centered around said pixel pᵢⱼ.

6. The method of claim 5 wherein said region is determined by a region value N, said region value N designating an N×N region of pixels centered around said pixel pᵢⱼ, selected pixels within said N×N region being designated as neighbor pixels.

7. The method of claim 6 wherein said neighbor pixels are determined by an interval value M, said interval value M designating every Mth pixel in said region as a neighbor pixel.

8. The method of claim 7 wherein during the comparing the average grayscale value of said neighbor pixels is compared with the grayscale value of said pixel pᵢⱼ.

9. The method of claim 8 wherein the average grayscale value is thresholded prior to said comparing.

10. The method of claim 9 wherein during thresholding, the average grayscale value is multiplied by a threshold value less than 1, said pixel pᵢⱼ being determined to represent recorded information if said pixel pᵢⱼ is darker than the thresholded average grayscale value.

11. The method of claim 11 further comprising the step of adjusting the colour of pixels representing recorded information to compensate for colour added to said image during capturing thereof by a camera.

12. The method of claim 11 wherein during said adjusting the average colour of said image is determined thereby to determine the colour added to said image.

13. The method of claim 11 wherein during said adjusting the average colour of pixels in said region is determined thereby to determine the colour added to said image.

14. A method of cleaning an image of a background surface on which information has been recorded, said method comprising the steps of:
for each pixel pᵢⱼ in said image:
creating an array holding grayscale values of neighbor pixels within a region surrounding said pixel pᵢⱼ;
calculating the average grayscale value of said neighbor pixels and thresholding said average grayscale value;
comparing the grayscale value of the pixel pᵢⱼ with the thresholded average grayscale value; and
retaining the pixel pᵢⱼ in said image if the grayscale value of said pixel differs from said thresholded average grayscale value, otherwise setting the value of the pixel pᵢⱼ to contrast pixels pᵢⱼ retained in said image.

15. The method of claim 14 further comprising the step of adjusting the colour of each retained pixel to compensate for colour added to said image during capturing thereof by a camera.

16. The method of claim 15 wherein during said adjusting, an average colour value representing the added colour is used to adjust the colour of pixels pᵢⱼretained in said image.

17. The method of claim 15 wherein during setting, the value of the pixel pᵢⱼ is set to white and wherein pixels pᵢⱼ having grayscale values darker than the thresholded average grayscale value are retained in said image.

18. The method of claim 17 wherein said region is centered around said pixel pᵢⱼ.

19. The method of claim 18 wherein said creating step includes the steps of using a region value N to determine the size of the region surrounding the pixel pᵢⱼand using an interval value M to determine the pixels within said region that are designated as neighbor pixels.

20. The method of claim 19 wherein said region value N designates a region including N×N pixels surrounding said pixel pᵢⱼ and wherein said interval value designates every Mth pixel in said region as a neighbor pixel.

22. The method of claim 20 wherein during said thresholding said average grayscale value is multiplied by a threshold value having a value in the range of from about 0.90 to 0.95.

23. The method of claim 22 where said creating step further includes the step of padding said array with additional grayscale pixel values copied from the margins of said image.

24. The method of claim 23 wherein the padding on each side of the array has a width equal to one half of the width of said region value.

25. The method of claim 16 wherein said average colour value is determined from the average colour of said image.

26. The method of claim 16 wherein said average colour value is determined from the average colour of pixels within said region.

27. A computer product including a computer program embodied thereon for cleaning an image of a background surface on which information has been recorded, said computer program comprising:
computer program code for comparing each pixel pᵢⱼ under consideration that is in said image with neighbor pixels within a region surrounding said pixel pᵢⱼ to determine whether said pixel pᵢⱼ represents recorded information or said background surface; and
computer program code for assigning the pixel pᵢⱼ under consideration a value to contrast pixels representing recorded information if the pixel pᵢⱼ represents said background surface.

28. A computer product according to claim 27 further comprising computer program code for adjusting the colour of pixels representing recorded information to compensate for colouring effects introduced into said image during image capture.

29. A computer product according to claim 28 wherein said computer program code for adjusting calculates the average colour of said image to determine the colouring effect and uses the average colour of said image to adjust the colour of pixels representing recorded information.

30. A computer product according to claim 28 wherein said computer program code for adjusting calculates the average colour of said region to determine the colouring effect and uses the average colour of said region to adjust the colour of pixels representing recorded information.

31. A computer product according to claim 28 wherein said computer program code for comparing compares the value of each pixel pᵢⱼ with the values of neighbor pixels to determine whether the value of the pixel pᵢⱼ appears to be the same as a threshold number of neighbor pixels and hence represents the background surface.

32. A computer product according to claim 31 wherein said computer program code for comparing compares the value of each pixel pᵢⱼ with the average pixel value of said neighbor pixels within an N×N region of pixels centered around and surrounding said pixel pᵢⱼ, every Mth pixel in said region being designated as a neighbor pixel.

33. A camera-based system for capturing an image of a target area comprising:
a generally horizontally extending boom assembly, said boom assembly being positioned above a background surface;
at least one digital camera mounted on said boom assembly at a location spaced from the plane of said background surface, said at least one digital camera being oriented so that the field of view thereof encompasses said background surface; and
a controller in communication with said at least one digital camera, said controller receiving image data from said at least one digital camera and processing said image data to form a cleaned digital image of said background surface, during said cleaning said controller retaining only pixels representing information recorded on said background surface.

34. A camera-based system according to claim 33 wherein during cleaning said controller, for each pixel pᵢⱼ under consideration that is in said image:
compares the pixel pᵢⱼ with neighbor pixels within a region surrounding said pixel pᵢⱼ to determine whether said pixel pᵢⱼ represents recorded information or said background surface; and
if the pixel pᵢⱼ represents said background surface, assigns the pixel pᵢⱼa value to contrast pixels representing recorded information.

35. A camera-based system according to claim 34 wherein said controller retains the colour values of pixels representing recorded information in said image sets the values of pixels representing said background surface to white.

36. A camera-based system according to claim 35 wherein said region is determined by a region value N, said region value N designating an N×N region of pixels centered around said pixel pᵢⱼ, selected pixels within said N×N region being designated as neighbor pixels.

37. A camera-based system according to claim 36 wherein said neighbor pixels are determined by an interval value M, said interval value M designating every Mth pixel in said region as a neighbor pixel.

38. A camera-based system according to claim 37 wherein said controller compares the average grayscale value of said neighbor pixels with the grayscale value of said pixel pᵢⱼ to determine whether to retain said pixel in said cleaned image.

39. A camera-based system according to claim 38 wherein said controller further adjusts the colour of pixels represented recorded information to compensate for colour added to said image during capturing thereof by said at least one camera.
